(19) United States
(12) Patent Application Publication
(10) Pub. No.: US 2026/0214177 A1
(43) Pub. Date: Jul. 23, 2026

(54) IMAGE FORMING APPARATUS AND IMAGE FORMING METHOD

(71) Applicant: Toshiba Tec Kabushiki Kaisha, Tokyo (JP)

(72) Inventor: Takashi TOMIYAMA, Sunto Shizuoka (JP)

(21) Appl. No.: 19/424,920

(22) Filed: Dec. 18, 2025

(30) Foreign Application Priority Data
Jan. 23, 2025 (JP) 2025-010146

(51) Int. Cl. H04N 1/32; H04N 1/00

(52) U.S. Cl. CPC H04N 1/32138; H04N 1/00342; H04N 1/0057

(57) ABSTRACT

According to an embodiment, an image forming apparatus acquires, when write processing of radio frequency tag recording data to radio frequency tags of a multi-tag sheet has failed, the radio frequency tag recording data for which the write processing has failed. The image forming apparatus performs the write processing of the acquired radio frequency tag recording data on a radio frequency tag of a single tag sheet.

### CROSS-REFERENCE TO RELATED APPLICATIONS

This application is based upon and claims the benefit of priority from the prior Japanese Patent Application No. 2025-010146, filed on Jan. 23, 2025, the entire contents of which are incorporated herein by reference.

### FIELD

An embodiment described herein generally relates to an image forming apparatus and an image forming method.

### BACKGROUND

There are sheets each provided with a radio frequency tag (RF tag) (hereinafter, referred to as a “radio frequency tag sheet”). There are image forming apparatuses that can form an image on such a radio frequency tag sheet and also write information to the radio frequency tag. Some of such image forming apparatuses eject the sheet provided with the radio frequency tag when it is determined that the write has been successfully performed.

By the way, there are two types of radio frequency tag sheet, one of which is a single sheet provided with a single radio frequency tag (hereinafter, referred to as a “single tag sheet”) and the other of which is a single sheet provided with a plurality of radio frequency tags (hereinafter, referred to as a “multi-tag sheet”). In the image forming apparatus, if the processing of writing information to a radio frequency tag of a radio frequency tag sheet is not successfully performed, such information needs to be written to a radio frequency tag of another radio frequency tag sheet. Such processing is referred to as “recovery write processing”. If the write to a single tag sheet fails, the write to another single tag sheet is performed again, so that the recovery write processing can be performed. However, there has been a possibility that if the write to a multi-tag sheet fails and then another multi-tag sheet is used in the recovery write processing, radio frequency tags that have not been used in the write among a plurality of radio frequency tags included in the multi-tag sheet become useless.

### BRIEF DESCRIPTION OF THE DRAWINGS

FIG. 1 is a schematic configuration diagram showing an image forming apparatus according to an embodiment.

FIG. 2 is a diagram showing a control system of the image forming apparatus according to the embodiment.

FIG. 3 is a diagram showing a specific example of a multi-tag sheet used in the image forming apparatus according to the embodiment.

FIG. 4 is a diagram showing a specific example of a single tag sheet used in the image forming apparatus according to the embodiment.

FIG. 5 is a flowchart showing a specific example of main processing of an image forming controller and a radio frequency tag communication device according to the embodiment.

FIG. 6 is a flowchart showing a first specific example of multi-tag write processing according to the embodiment.

FIG. 7 is a flowchart showing a first specific example of recovery write processing according to the embodiment.

FIG. 8 is a flowchart showing a second specific example of the multi-tag write processing according to the embodiment.

FIG. 9 is a flowchart showing a second specific example of the recovery write processing according to the embodiment.

FIG. 10 is a flowchart showing a modification of the main processing according to the embodiment.

### DETAILED DESCRIPTION

According to an embodiment, an image forming apparatus includes a radio frequency tag communication device, a first medium feeding device, a second medium feeding device, a storage device, and a controller. The radio frequency tag communication device performs write processing of data on a radio frequency tag provided to a printing medium conveyed through a conveyance path. The first medium feeding device supplies a multi-tag sheet provided with a plurality of radio frequency tags to the conveyance path. The second medium feeding device supplies a single tag sheet provided with a single radio frequency tag to the conveyance path. The storage device stores, when write processing of radio frequency tag recording data to the plurality of radio frequency tags of the multi-tag sheet has failed, the radio frequency tag recording data for which the write processing has failed. The controller acquires, when the write processing of the radio frequency tag recording data to the plurality of radio frequency tags of the multi-tag sheet has failed, the radio frequency tag recording data for which the write processing has failed from the storage device, and performs the write processing of the acquired radio frequency tag recording data on the radio frequency tag of the single tag sheet.

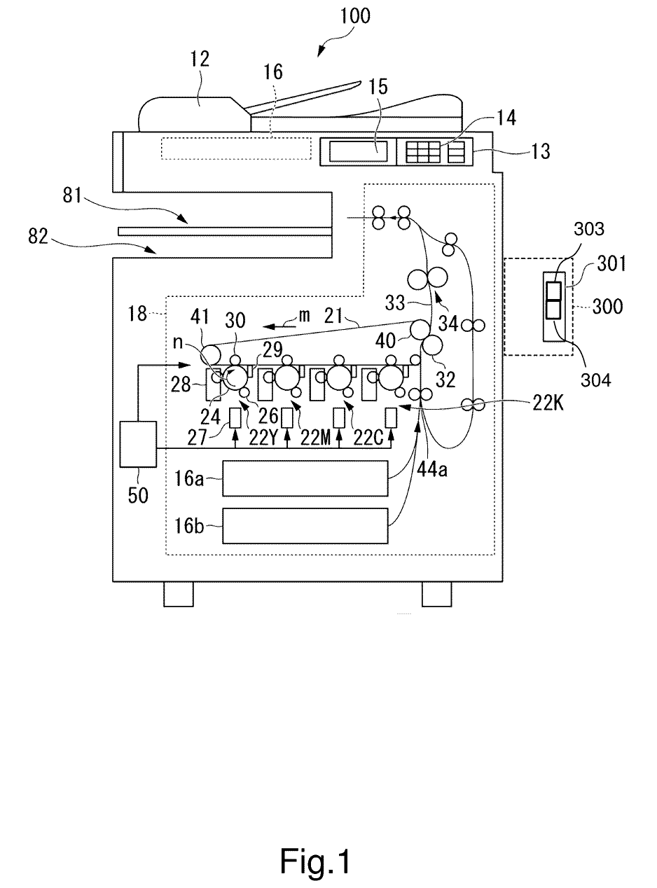

Hereinafter, an image forming apparatus and an image forming method according to an embodiment will be described with reference to the drawings. In the drawings, the same reference symbols denote the same or similar portions. FIG. 1 is a schematic configuration diagram showing an example of an image forming apparatus 100 according to an embodiment. In the image forming apparatus 100 according to the embodiment, an image can be formed also on a sheet provided with a radio frequency tag. The image forming apparatus 100 is a multi-function peripheral (MFP) that is a multifunctional machine, a printer, a copying machine, or the like.

In FIG. 1, the image forming apparatus 100 is provided with a document glass (not shown) at the top thereof, and an auto document feeder (ADF) 12 is provided on the document glass in an openable and closable manner. The image forming apparatus 100 is further provided with a control panel 13 at the top thereof. The control panel 13 includes an operation device 14 including various keys, and a display device 15 of a touch panel type. The display device 15 is a specific example of an output device that outputs data in a form that can be recognized by a user. Instead of the display device 15, an output device according to another aspect that outputs data in a form that can be recognized by a user may also be provided to the image forming apparatus 100. For example, a speaker that outputs sounds may be provided.

The image forming apparatus 100 includes a scanner device 16. The scanner device 16 reads documents fed by the ADF 12 or documents put on the document glass. The image forming apparatus 100 includes a radio frequency tag communication device 300 and a printer device 18. An image forming controller 50 controls the ADF 12, the control panel 13, the scanner device 16, the printer device 18, and the radio frequency tag communication device 300. The image forming controller 50 controls the operation of a conveying and driving device in the printer device 18, to thereby control conveyance of sheets. A radio frequency tag in this embodiment is, for example, a radio frequency (RF) tag. Note that the installation position of the radio frequency tag communication device 300 shown in FIG. 1 is merely one specific example. Unless otherwise limited in the following description, the installation position of the radio frequency tag communication device 300 need not be limited to the specific position as shown in FIG. 1.

A first paper feed cassette 16a and a second paper feed cassette 16b each house a bundle of sheets. The first paper feed cassette 16a may house a bundle of multi-tag sheets. The first paper feed cassette 16a and the second paper feed cassette 16b are a specific example of a first medium feeding device and a specific example of a second medium feeding device, respectively. The second paper feed cassette 16b may house a bundle of single tag sheets. In such a manner, the image forming apparatus 100 includes a device that feeds multi-tag sheets and a device that feeds single tag sheets.

The printer device 18 forms images. For example, the printer device 18 forms an image represented by image data. In the following description, forming images is also referred to as printing. The printer device 18 includes an intermediate transfer belt 21. The printer device 18 supports the intermediate transfer belt 21 by using a driven roller 41, a backup roller 40, and the like. The printer device 18 rotates the intermediate transfer belt 21 in a direction indicated by the arrow m.

The printer device 18 includes four sets of image forming stations 22Y, 22M, 22C, and 22K. The image forming stations 22Y, 22M, 22C, and 22K are devices for forming images of Y (yellow), M (magenta), C (cyan), and K (black). The image forming stations 22Y, 22M, 22C, and 22K are disposed below the intermediate transfer belt 21 along the rotating direction of the intermediate transfer belt 21.

Hereinafter, in the image forming stations 22Y, 22M, 22C, and 22K, the image forming station 22Y of Y (yellow) will be described as an example. Note that each of the image forming stations 22M, 22C, and 22K has a configuration similar to that of the image forming stations 22Y, and thus detailed description thereof will be omitted.

The image forming stations 22Y includes an electrostatic charger 26, an exposure scanning head 27, a developing device 28, and a photoconductor cleaner 29. The electrostatic charger 26, the exposure scanning head 27, the developing device 28, and the photoconductor cleaner 29 are disposed around a photoconductor drum 24 that rotates in a direction indicated by the arrow n.

The image forming station 22Y includes a primary transfer roller 30. The primary transfer roller 30 faces the photoconductor drum 24 via the intermediate transfer belt 21. The image forming station 22Y exposes the photoconductor drum 24 by the exposure scanning head 27 after charging the photoconductor drum 24 by the electrostatic charger 26. The image forming station 22Y forms an electrostatic latent image on the photoconductor drum 24. The developing device 28 develops the electrostatic latent image on the photoconductor drum 24 by using a two-component developer formed of toner and carrier.

The primary transfer roller 30 primarily transfers a toner image formed on the photoconductor drum 24 to the intermediate transfer belt 21. The image forming stations 22Y, 22M, 22C, and 22K form color toner images on the intermediate transfer belt 21 by the primary transfer rollers 30. The color toner images are formed by sequentially overlaying the toner images of Y (yellow), M (magenta), C (cyan), and K (black). The photoconductor cleaner 29 removes the toner remaining on the photoconductor drum 24 after the primary transfer.

The printer device 18 includes a secondary transfer roller 32. The secondary transfer roller 32 faces the backup roller 40 via the intermediate transfer belt 21. The secondary transfer roller 32 secondarily transfers in a batch the color toner images on the intermediate transfer belt 21 to a sheet.

The image forming apparatus 100 includes a conveyance path 33. The conveyance path includes a space through which a sheet is conveyed, and a conveying and driving device that rotates to move the sheet within the conveyance path. The conveying and driving device includes a conveyance roller that rotates to nip and move the sheet, for example, and a motor that rotates the conveyance roller. The image forming controller 50 controls the rotation of the motor to control the conveyance of the sheet.

The image forming controller 50 conveys a taken-out sheet toward the conveyance path 33 and fixes the toner images by a fixing device 34, to thereby form an image on the sheet. The image forming controller 50 conveys the sheet on which the image has been formed to the conveyance path 33, to thereby eject the sheet.

The image forming controller 50 takes out a radio frequency tag sheet to be processed from the first paper feed cassette 16a or the second paper feed cassette 16b. The image forming controller 50 conveys the taken-out radio frequency tag sheet toward the conveyance path 33. The image forming controller 50 performs write processing on the radio frequency tag sheet by the radio frequency tag communication device 300. The image forming controller 50 forms an image on the radio frequency tag sheet by fixing the toner images by the fixing device 34. The image forming controller 50 conveys the radio frequency tag sheet on which the image has been formed to the conveyance path 33, and ejects the sheet to an upper paper ejection tray 81 or a lower paper ejection tray 82.

The radio frequency tag communication device 300 includes a radio frequency tag communication controller 301, and a transmitter circuit, a receiver circuit, and an antenna (not shown). The radio frequency tag communication device 300 corresponds to a tag communication device. The radio frequency tag communication device 300 may be configured to be detachable from the image forming apparatus 100. The radio frequency tag communication device 300 wirelessly communicates with the radio frequency tag of the radio frequency tag sheet located in the conveyance path 33.

The radio frequency tag communication controller 301 includes an arithmetic device and a storage device. Additionally, the radio frequency tag communication controller 301 includes a read section 303 and a write section 304. The radio frequency tag communication controller 301 controls the read section 303 and the write section 304. In addition, the radio frequency tag communication controller 301 can communicate with the image forming controller 50. The radio frequency tag communication controller 301 can know in advance that a radio frequency tag sheet is located in the conveyance path 33, in response to a notification from the image forming controller 50.

The read section 303 reads information from the radio frequency tag. The information read by the read section 303 (hereinafter, referred to as “read information”) is transmitted to the image forming controller 50 by the radio frequency tag communication controller 301. The write section 304 writes information (hereinafter, referred to as “tag information”) to the radio frequency tag of the radio frequency tag sheet. The write section 304 writes, for example, tag information corresponding to an instruction of the image forming controller 50 to the radio frequency tag. The write section 304 can disable the radio frequency tag or delete the information of the radio frequency tag.

The developing method of the image forming apparatus 100 described above is a tandem developing method, but it is not limited to this method. In addition, the number of developing devices 28 is also not limited.

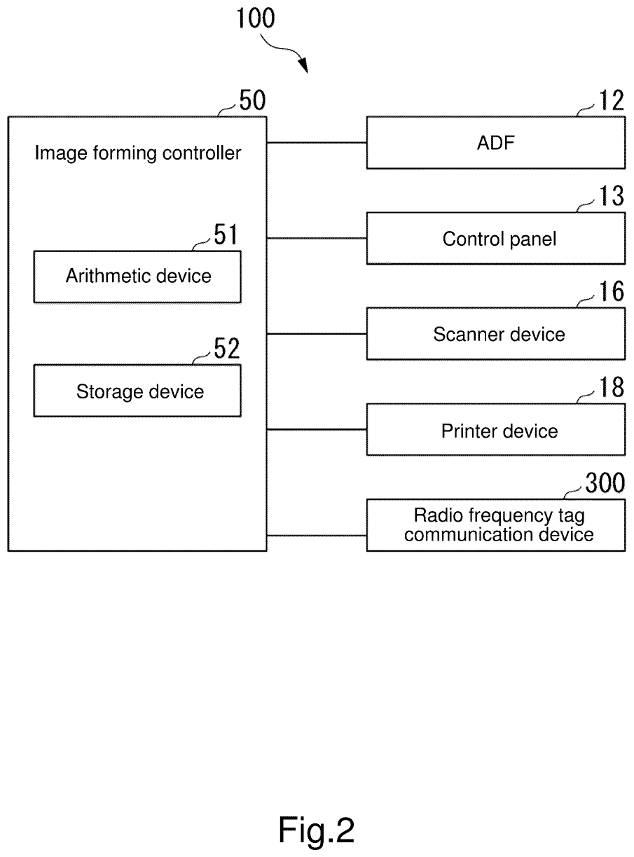

FIG. 2 is a diagram showing a control system of the image forming apparatus 100. In FIG. 2, the image forming controller 50 includes an arithmetic device 51 and a storage device 52. The arithmetic device 51 controls the ADF 12, the control panel 13, the scanner device 16, the printer device 18, and the radio frequency tag communication device 300 according to various programs stored in the storage device 52.

The arithmetic device 51 is, for example, a central processing unit (CPU) or an application specific integrated circuit (ASIC). The storage device 52 is a read only memory (ROM), a random access memory (RAM), or the like. Note that each of the ADF 12, the control panel 13, the scanner device 16, the printer device 18, and the radio frequency tag communication device 300 may include an arithmetic device and a storage device.

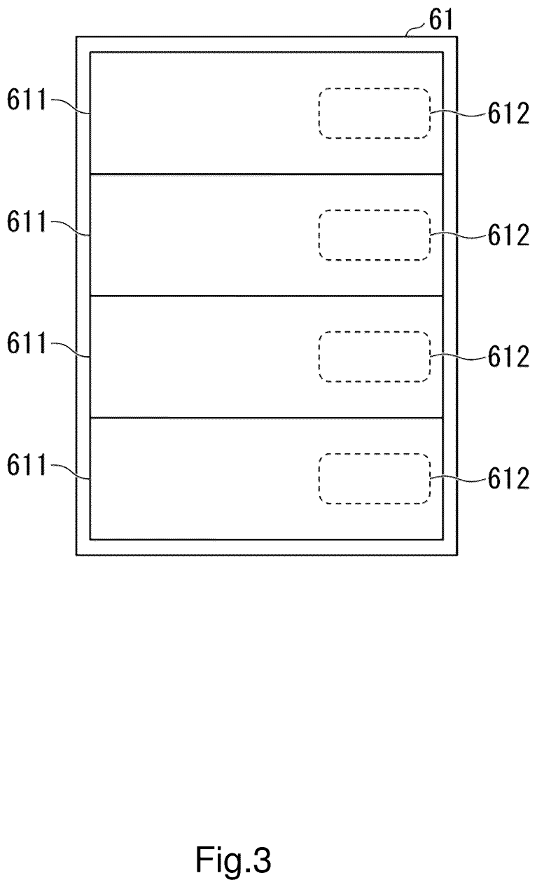

FIG. 3 is a diagram showing a specific example of a multi-tag sheet used in the image forming apparatus 100. A multi-tag sheet 61 has a plurality of unit regions 611. In the example of FIG. 3, the multi-tag sheet 61 has four unit regions 611. Each unit region 611 is provided with at least one radio frequency tag 612. The radio frequency tag 612 may be provided on a surface of the sheet or may be provided inside the sheet. An image may be formed on the surface of the unit region 611 by the image forming apparatus 100. In this case, for example, an image formed in the unit region 611 and data recorded on the radio frequency tag 612 provided in that unit region 611 may be associated with each other and transmitted to the image forming apparatus 100. Recording on the radio frequency tag and image-forming are performed according to such data, which makes it possible to provide relevance to contents of the image formed in the unit region 611 and contents of the data recorded on the radio frequency tag 612.

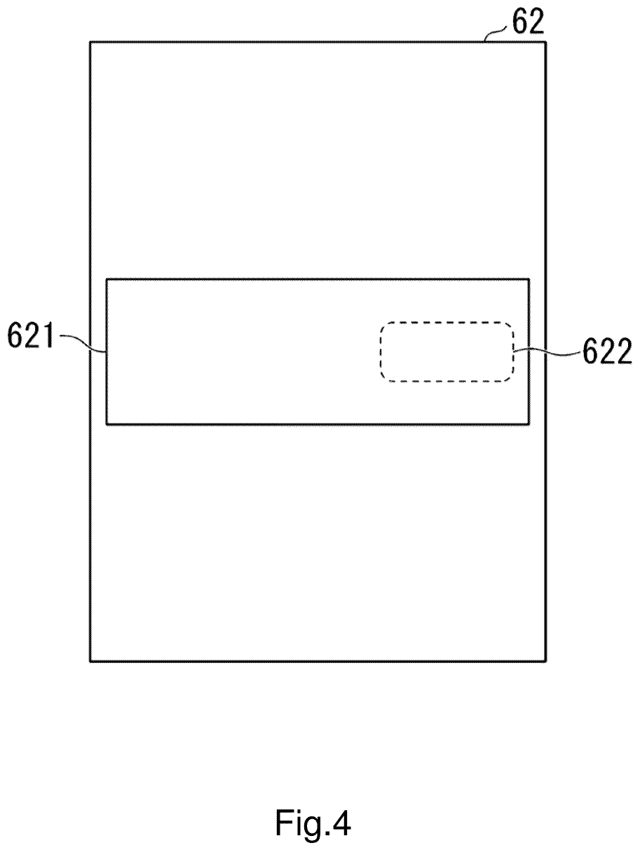

FIG. 4 is a diagram showing a specific example of a single tag sheet used in the image forming apparatus 100. A single tag sheet 62 has a single unit region 621. The unit region 621 is provided with a single radio frequency tag 622. The radio frequency tag 622 may be provided on a surface of the sheet or may be provided inside the sheet. An image may be formed on the surface of the unit region 621 by the image forming apparatus 100. The relationship between an image formed in the unit region 621 and data recorded on the radio frequency tag 622 is similar to that in the case of the multi-tag sheet described above.

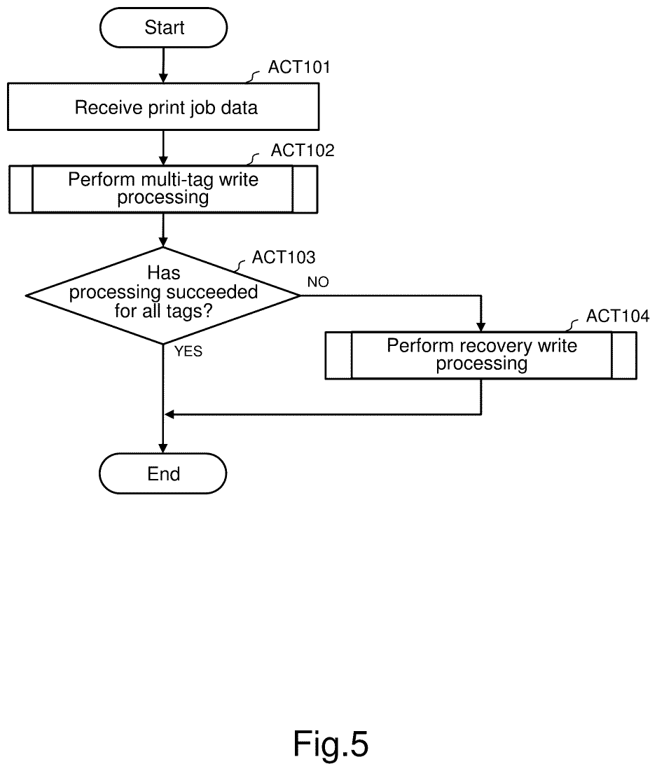

Next, control contents of the image forming controller 50 and the radio frequency tag communication device 300 will be described using flowcharts. FIG. 5 is a flowchart showing a specific example of main processing of the image forming controller 50 and the radio frequency tag communication device 300. In the main processing, the image forming controller 50 processes one piece of print job data. One piece of print job data contains a plurality of radio frequency tag write instructions. The radio frequency tag write instruction contains at least data to be written to a radio frequency tag (hereinafter, referred to as “radio frequency tag recording data”). A set of radio frequency tag write instructions for a plurality of radio frequency tags (e.g., all radio frequency tags) included in one multi-tag sheet is contained in one piece of print job data. Thus, when one piece of print job data is processed, write processing is performed on all the radio frequency tags of at least one multi-tag sheet.

First, the image forming controller 50 receives print job data (ACT101). The image forming controller 50 may receive print job data, for example, from another information processing apparatus communicatively connected. Next, the image forming controller 50 performs multi-tag write processing (ACT102). In the multi-tag write processing, the image forming controller 50 performs processing of wiring the radio frequency tag recording data to the multi-tag sheet. In the multi-tag write processing, if the write to all the radio frequency tags included in the same multi-tag sheet has succeeded (ACT103-YES), the main processing is terminated. In the multi-tag write processing, if the write to at least one radio frequency tag included in the same multi-tag sheet has failed (ACT103-NO), the image forming controller 50 performs recovery write processing (ACT104).

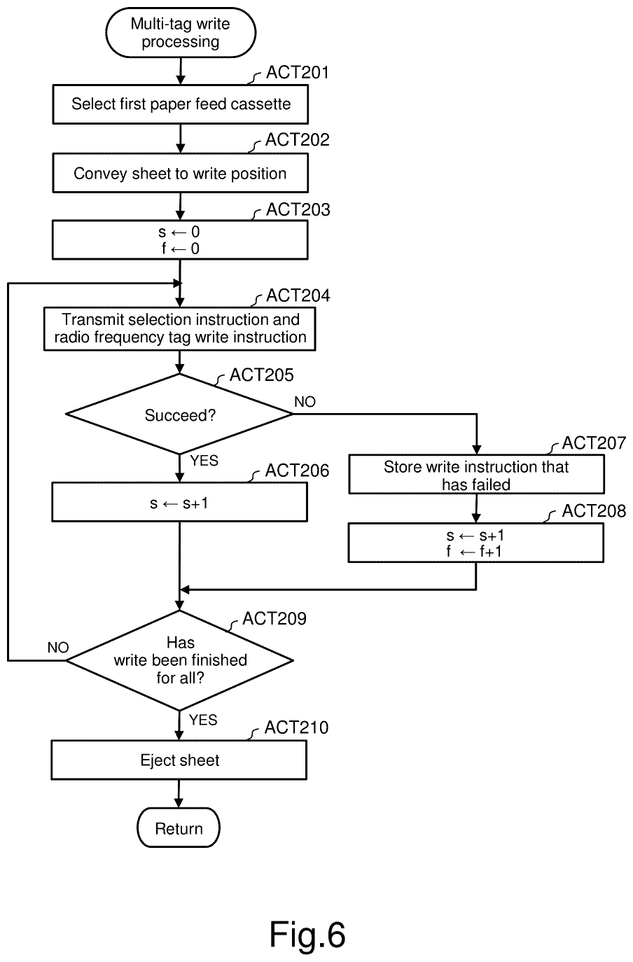

FIG. 6 is a flowchart showing a first specific example of the multi-tag write processing. First, the image forming controller 50 selects the first paper feed cassette 16a as a paper feeding source (ACT201). The image forming controller 50 operates a conveying and driving device of a pickup roller and a conveyance roller of the first paper feed cassette 16a to convey a multi-tag sheet to a write position for a radio frequency tag (ACT202). Here, the image forming controller 50 assigns “0” to each of a variable s and a variable f (ACT203). The image forming controller 50 transmits a selection instruction indicating a radio frequency tag to be processed and a radio frequency tag write instruction to the radio frequency tag communication device 300 (ACT204).

When receiving the radio frequency tag write instruction, the radio frequency tag communication device 300 transmits the selection instruction and the radio frequency tag write instruction according to the received radio frequency tag write instruction. It is desirable that a write position is set in advance in a transmission destination of the radio frequency tag communication device 300 such that the multi-tag sheet is stopped. In response to the transmission of the radio frequency tag communication device 300, the radio frequency tag recording data is recorded on a radio frequency tag corresponding to the selection instruction. The radio frequency tag communication device 300 determines whether or not the execution of the radio frequency tag write instruction (recording of radio frequency tag recording data) has succeeded (ACT205). For example, the radio frequency tag communication device 300 may read information from the radio frequency tag corresponding to the selection instruction, and may determine that the execution has succeeded if the read data and the data indicated by the radio frequency tag write instruction (radio frequency tag recording data) match, or may determine that the execution has failed if both the data do not match with each other.

If it is determined that the execution has succeeded (ACT205-YES), the image forming controller 50 increments the variable s (ACT206). On the other hand, if it is determined that the execution has failed (ACT205-NO), the image forming controller 50 stores the radio frequency tag write instruction that has failed in the storage device 52 (ACT207). At that time, the image forming controller 50 may record the value of the variable s at the time in association with the radio frequency tag write instruction that has failed. The image forming controller 50 then increments the variable s and the variable f (ACT208).

After ACT206 or ACT208, the image forming controller 50 determines whether or not the write processing to all the radio frequency tags included in the multi-tag sheet to be processed has been finished (ACT209). If the write processing has not been finished (ACT209-NO), the processing is returned back to ACT204, and the processing for the next radio frequency tag write instruction is performed. If the write processing has been finished (ACT209-YES), the image forming controller 50 operates the conveying and driving device of the conveyance roller and the paper ejection roller to eject the multi-tag sheet on which the radio frequency tag recording data has been recorded (ACT210), and the multi-tag write processing is terminated.

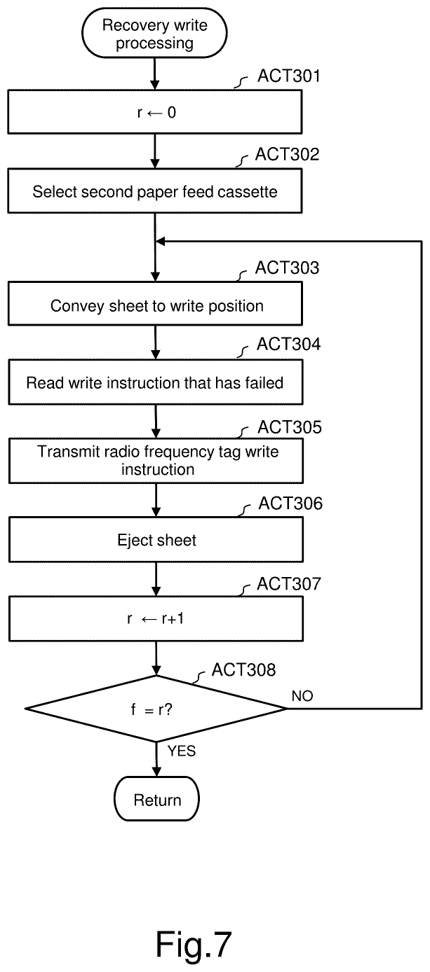

FIG. 7 is a flowchart showing a first specific example of the recovery write processing. First, the image forming controller 50 assigns “0” to a variable r (ACT301). The image forming controller 50 selects the second paper feed cassette 16b as a paper feeding source (ACT302). The image forming controller 50 operates a conveying and driving device of a pickup roller and a conveyance roller of the second paper feed cassette 16b to convey a single tag sheet to a write position for a radio frequency tag (ACT303). The image forming controller 50 reads the radio frequency tag write instruction that has failed (ACT304). At that time, if there are radio frequency tag write instructions that have failed, the radio frequency tag write instructions are read according to FIFO. For example, the radio frequency tag write instructions recorded in the order corresponding to the variable r may be read. In this case, in the processing of ACT207 of the multi-tag write processing, when the radio frequency tag write instruction is recorded, it may be recorded in association with the value of the variable f at the time. The radio frequency tag write instruction recorded in association with the value of the variable f that matches with the value of the variable r may be read. The image forming controller 50 transmits the read radio frequency tag write instruction to the radio frequency tag communication device 300 (ACT305).

When receiving the instruction, the radio frequency tag communication device 300 transmits the radio frequency tag write instruction according to the received radio frequency tag write instruction. It is desirable that a write position is set in advance in a transmission destination of the radio frequency tag communication device 300 such that the single tag sheet is stopped. In response to the transmission of the radio frequency tag communication device 300, the radio frequency tag recording data is recorded on the radio frequency tag of the single tag sheet. The image forming controller 50 operates the conveying and driving device of the pickup roller and the conveyance roller to eject the single tag sheet on which the radio frequency tag recording data has been recorded (ACT306). The image forming controller 50 increments the variable r (ACT307). The image forming controller 50 determines whether or not the processing for all the radio frequency tag write instructions that have failed has been finished. Specifically, the image forming controller 50 determines whether or not the value of the variable r matches with the current value of the variable f (ACT308). If the values do not match, that is, if the processing has not been finished (ACT308-NO), the processing is returned back to ACT303, and the processing for the next radio frequency tag write instruction is performed. If the processing has been finished (ACT308-YES), the recovery write processing is terminated.

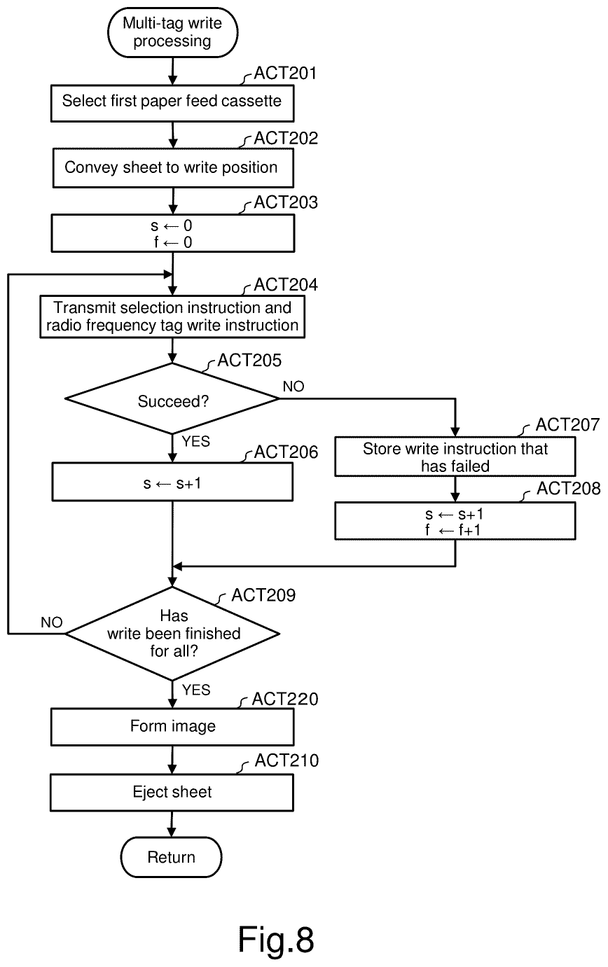

FIG. 8 is a flowchart showing a second specific example of the multi-tag write processing. For the second specific example of the multi-tag write processing, only the points different from the first specific example will be described. In the second specific example, image-forming corresponding to the print data of the radio frequency tag write instruction is performed on each unit region 611. In the second specific example, one piece of print job data contains a plurality of radio frequency tag write instructions. The radio frequency tag write instruction contains at least radio frequency tag recording data and print data.

After the processing of ACT209, the image forming controller 50 conveys the multi-tag sheet to an image-forming position. The image forming controller 50 forms an image in each unit region 611 of the multi-tag sheet by using the print data corresponding to the radio frequency tag recording data recorded on the radio frequency tag 612 of that unit region 611 (ACT220). At that time, the image forming controller 50 may determine whether or not there has been a failure in the write processing. For example, the determination may be performed on the basis of whether the value of the variable f is “0” or not. If the value of the variable f is “0”, that is, if there have been no failures, the image forming controller 50 forms images in all the unit regions 611 according to the print data corresponding to the respective unit regions 611.

On the other hand, if the value of the variable f is not “0”, that is, if there has been a failure, the image forming controller 50 forms a failure pattern image in the unit region 611 in which a failure has occurred. The failure pattern image is an image indicating that the recording of the radio frequency tag recording data has failed for the radio frequency tag 612 corresponding to that unit region 611. The radio frequency tag for which the recording has failed may be determined, for example, on the basis of the value of the variable s recorded in association with the radio frequency tag write instruction that has failed. Additionally, no image may be formed in the unit region 611 of the radio frequency tag for which the recording of the radio frequency tag recording data has failed. In this case, in accordance with the fact that no image is formed in the unit region 611, a user can recognize that the recoding has failed for the radio frequency tag 612 of that unit region 611. After the processing of ACT220, the image forming controller 50 ejects the multi-tag sheet (ACT210).

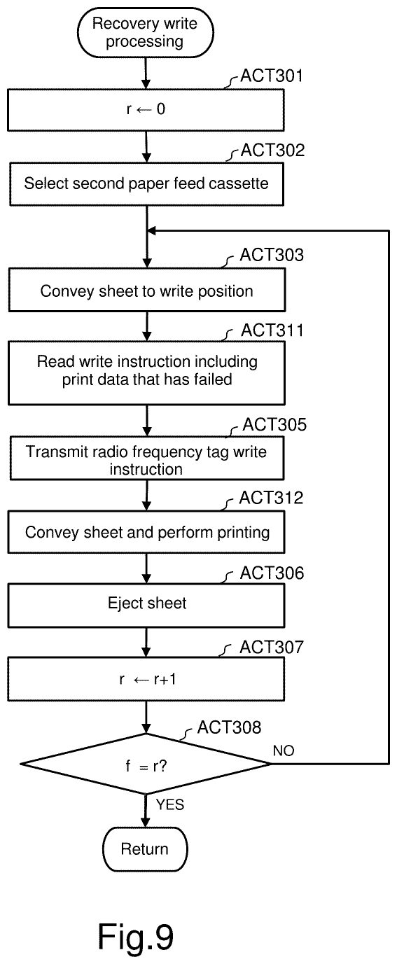

FIG. 9 is a flowchart showing a second specific example of the recovery write processing. For the second specific example of the recovery write processing, only the points different from the first specific example will be described. In the second specific example, image-forming corresponding to the print data of the radio frequency tag write instruction is performed on each unit region 611. The recovery write processing performed after the second specific example of the multi-tag write processing is performed is the processing of this second specific example.

After the processing of ACT303, the image forming controller 50 reads the radio frequency tag write instruction (radio frequency tag recording data and print data) that has failed from the storage device 52. The image forming controller 50 transmits the read radio frequency tag write instruction to the radio frequency tag communication device 300 (ACT305). When receiving the instruction, the radio frequency tag communication device 300 transmits the radio frequency tag recording data according to the received radio frequency tag write instruction. It is desirable that a write position is set in advance in a transmission destination of the radio frequency tag communication device 300 such that the single tag sheet is stopped. In response to the transmission of the radio frequency tag communication device 300, the radio frequency tag recording data is recorded on the radio frequency tag of the single tag sheet. The image forming controller 50 operates the conveying and driving device of the conveyance roller to convey the single tag sheet to an image-forming position. The image forming controller 50 forms an image in the unit region 621 of the single tag sheet by using the print data corresponding to the radio frequency tag recording data recorded on the radio frequency tag 622 of that unit region 621 (ACT312). The image forming controller 50 then operates the conveying and driving device of the conveyance roller and the paper ejection roller to eject the single tag sheet on which the radio frequency tag recording data has been recorded (ACT306).

According to the embodiment described above, the image forming controller 50 makes it possible to achieve the recovery write processing while suppressing the number of radio frequency tags that become useless, when recording on a radio frequency tag is not successfully performed in a multi-tag sheet.

### Modification

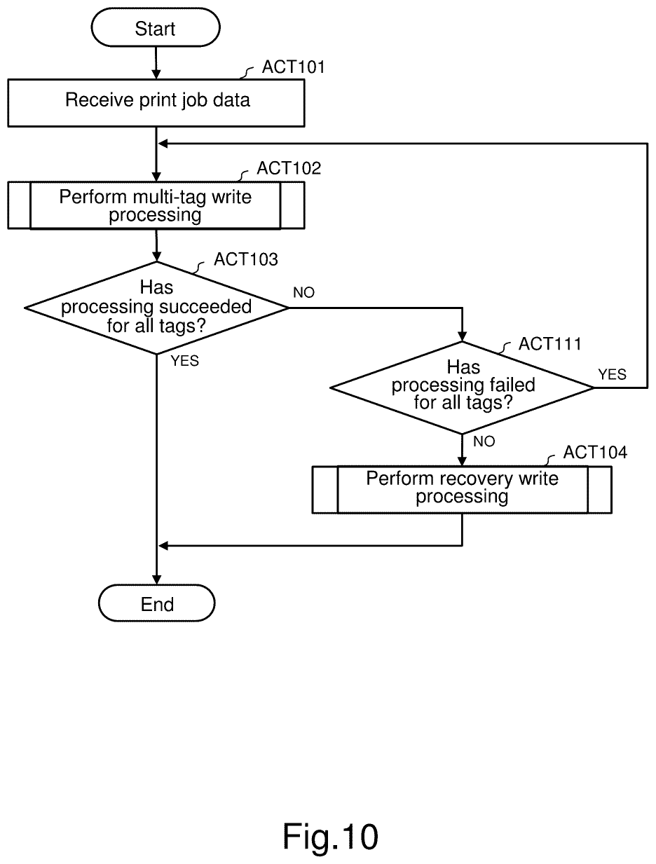

FIG. 10 is a flowchart showing a modification of the main processing. In the main processing, if the write processing has failed for all the radio frequency tags 612 of the multi-tag sheet to be processed (ACT111-YES), instead of performing the recovery write processing (ACT104), the multi-tag write processing (ACT102) may be performed again on the next multi-tag sheet using the same print job data. In this case, recording using single tag sheets in the same number as the number of radio frequency tags 612 included in the multi-tag sheet is stopped, whereas recording using one multi-tag sheet is performed. This can achieve efficient recording using the multi-tag sheets, thus enhancing convenience of the user.

In the above description, the device that feeds the multi-tag sheet to the image forming apparatus 100 is the first paper feed cassette 16a, and the device that feeds the single tag sheet to the image forming apparatus 100 is the second paper feed cassette 16b. However, both the device that feeds the multi-tag sheet to the image forming apparatus 100 and the device that feeds the single tag sheet to the image forming apparatus 100 are not necessarily limited to the above-mentioned paper feed cassettes. For example, the device that feeds the multi-tag sheet to the image forming apparatus 100 may be the second paper feed cassette 16b, and the device that feeds the single tag sheet to the image forming apparatus 100 may be the first paper feed cassette 16a. Additionally, either of the multi-tag sheet or the single tag sheet may be fed to the image forming apparatus 100 by a manual feeding device. The manual feeding device is a specific example of the first medium feeding device and a specific example of the second medium feeding device.

The function of the image forming controller 50 in the embodiment described above may be implemented by a computer. In such a case, a program for implementing the function may be recorded on a computer-readable recording medium and read into a computer system to be executed. Note that the “computer system” used herein includes an operating system (OS) or hardware such as a peripheral device. Additionally, the “computer-readable recording medium” refers to a portable medium such as a flexible disk, a magneto-optical disk, a ROM, or a CD-ROM, or another storage device such as a hard disk built into a computer system. Further, the “computer-readable recording medium” also includes one that dynamically retains a program for a short period of time, like a communication line used when a program is transmitted via a network such as the Internet or a telecommunication line such as a telephone line, and one that retains a program for a certain period of time, like a volatile memory inside a computer system that serves as a server or client in that case. Further, the program described above may be a program for implementing part of the function described above, or a program that can implement the function described above in combination of the program already recorded on the computer system.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus, comprising:
a radio frequency tag communication device configured to perform write processing of data on a radio frequency tag provided to a printing medium conveyed through a conveyance path;
a first medium feeding device configured to supply a multi-tag sheet provided with a plurality of radio frequency tags to the conveyance path;
a second medium feeding device configured to supply a single tag sheet provided with a single radio frequency tag to the conveyance path;
a storage device configured to store, when write processing of radio frequency tag recording data to the plurality of radio frequency tags of the multi-tag sheet has failed, the radio frequency tag recording data for which the write processing has failed; and
a controller configured to
acquire, when the write processing of the radio frequency tag recording data to the plurality of radio frequency tags of the multi-tag sheet has failed, the radio frequency tag recording data for which the write processing has failed from the storage device, and
perform the write processing of the acquired radio frequency tag recording data on the radio frequency tag of the single tag sheet.

2. The image forming apparatus according to claim 1, wherein
the controller acquires, after the write processing is performed on all the plurality of radio frequency tags of the multi-tag sheet, the radio frequency tag recording data for which the write processing has failed from the storage device.

3. The image forming apparatus according to claim 2, wherein
the controller performs the write processing of the acquired radio frequency tag recording data on the radio frequency tag of the single tag sheet.

4. The image forming apparatus according to claim 1, further comprising
a printer device that forms an image corresponding to print data on a sheet, wherein
the controller forms an image of print data corresponding to the radio frequency tag recording data recorded on the radio frequency tag in a region of the sheet corresponding to the radio frequency tag.

5. The image forming apparatus according to claim 4, wherein
the controller forms an image indicating that the write processing of the radio frequency tag recording data has failed, in a region of the multi-tag sheet corresponding to the radio frequency tag for which the write processing of the radio frequency tag recording data has failed.

6. The image forming apparatus according to claim 4, wherein
the controller forms no images in the region of the multi-tag sheet corresponding to the radio frequency tag for which the write processing of the radio frequency tag recording data has failed.

7. The image forming apparatus according to claim 4, wherein
the controller forms an image of the print data corresponding to the radio frequency tag recording data recorded on the radio frequency tag in a region of the sheet corresponding to the radio frequency tag of the single tag sheet.

8. The image forming apparatus according to claim 1, wherein
the controller performs, when the write processing of the radio frequency tag recording data to the plurality of radio frequency tags of the multi-tag sheet has failed, write processing of each piece of the radio frequency tag recording data for which the write processing has failed, on single tag sheets in the same number as the radio frequency tags for which the write processing has failed.

9. The image forming apparatus according to claim 1, wherein
the controller performs, when the write processing of the radio frequency tag recording data to all the plurality of radio frequency tags of the multi-tag sheet has failed, the write processing of all the radio frequency tag recording data on another multi-tag sheet again.

10. An image forming method, comprising:
performing write processing of data on a radio frequency tag provided to a printing medium conveyed through a conveyance path;
supplying a multi-tag sheet provided with a plurality of radio frequency tags to the conveyance path;
supplying a single tag sheet provided with a single radio frequency tag to the conveyance path;
storing, when write processing of radio frequency tag recording data to the plurality of radio frequency tags of the multi-tag sheet has failed, the radio frequency tag recording data for which the write processing has failed in a storage device; and
acquiring, when the write processing of the radio frequency tag recording data to the plurality of radio frequency tags of the multi-tag sheet has failed, the radio frequency tag recording data for which the write processing has failed from the storage device, and performing the write processing of the acquired radio frequency tag recording data on the radio frequency tag of the single tag sheet.

11. An information writing apparatus, comprising:
a radio frequency tag communication device configured to perform write processing of data on a radio frequency tag provided to a sheet conveyed through a conveyance path;
a first medium feeding device configured to supply a multi-tag sheet provided with a plurality of radio frequency tags to the conveyance path;
a second medium feeding device configured to supply a single tag sheet provided with a single radio frequency tag to the conveyance path;
a storage device configured to store, when write processing of radio frequency tag recording data to the plurality of radio frequency tags of the multi-tag sheet has failed, the radio frequency tag recording data for which the write processing has failed; and
a controller configured to
acquire, when the write processing of the radio frequency tag recording data to the plurality of radio frequency tags of the multi-tag sheet has failed, the radio frequency tag recording data for which the write processing has failed from the storage device, and
perform the write processing of the acquired radio frequency tag recording data on the radio frequency tag of the single tag sheet.

12. The information writing apparatus according to claim 11, wherein
the controller acquires, after the write processing is performed on all the plurality of radio frequency tags of the multi-tag sheet, the radio frequency tag recording data for which the write processing has failed from the storage device.

13. The information writing apparatus according to claim 12, wherein
the controller performs the write processing of the acquired radio frequency tag recording data on the radio frequency tag of the single tag sheet.

14. The information writing apparatus according to claim 11, wherein
the controller performs, when the write processing of the radio frequency tag recording data to the plurality of radio frequency tags of the multi-tag sheet has failed, write processing of each piece of the radio frequency tag recording data for which the write processing has failed, on single tag sheets in the same number as the radio frequency tags for which the write processing has failed.

15. The information writing apparatus according to claim 11, wherein
the controller performs, when the write processing of the radio frequency tag recording data to all the plurality of radio frequency tags of the multi-tag sheet has failed, the write processing of all the radio frequency tag recording data on another multi-tag sheet again.
